(19) United States
(12) Patent Application Publication
(10) Pub. No.: US 2002/0189772 A1
(43) Pub. Date: Dec. 19, 2002

(54) New structural and decorative material and method

(76) Inventor: Eric Anthony Knight, Unionville, CT (US)

Correspondence Address: Eric A. Knight, 7 Cove Circle, Unionville, CT, 06085, US

(21) Appl. No.: 09/883,560

(22) Filed: Jun. 18, 2001

(51) Int. Cl. D21B 1/08; C04B 18/18; D21B 1/32; D21C 5/02

(52) U.S. Cl. 162/4; 106/697

(57) ABSTRACT

The present invention is concerned with a new structural and decorative material that is comprised of a mixture of pulped paper, cement, and water. The new material offers a number of beneficial properties over traditional cement derivatives. Potential applications range from light-to-medium-duty construction to incredibly demanding applications in the aerospace industry. New uses and applications are being discovered continuously. Additionally, the use of the new material can play a significant role in the reduction of waste paper, the largest component of municipal solid waste in the United States. Additionally, since a wide range of water types and quality can be used in the fabrication of the new material, the present invention may offer a use for marginal-quality water that would otherwise be too costly to purify for human or animal consumption. An example method for preparing the new material is also provided.

### BACKGROUND—FIELD OF INVENTION

The present invention is concerned with a new structural and decorative material that is comprised of a mixture of pulped paper, cement, and water. The new material offers a number of beneficial properties over traditional cement derivatives. Potential applications range from light-to-medium-duty construction to incredibly demanding applications in the aerospace industry. New uses and applications are being discovered continuously.

Additionally, the use of the new material can play a significant role in the reduction of waste paper, the largest component of municipal solid waste in the United States.

Additionally, since a wide range of water types and quality can be used in the fabrication of the new material, the present invention may offer a use for marginal-quality water that would otherwise be too costly to purify for human or animal consumption.

An example method for preparing the new material is also provided.

### BACKGROUND—OVERVIEW OF INVENTION COMPONENTS

One component of the new material is cement. Cement is essentially comprised of powdered calcined rock and clay. When the cement is mixed with water, another component of the present invention, the mixture turns into a viscous substance; over time (from hours to days), this substance cures into a solid mass. While cement is in its viscous state, it is common to add solid inorganic materials to ultimately create a solidified material with various properties. Mixed with sand and gravel, it forms concrete. Mixed with hydrated lime and sand, it forms mortar. Steel bars and metal netting are commonly set into poured concrete to create materials with improved strength.

Another component of the new material is paper. Paper is an organic material essentially composed of thin sheets of cellular pulp, derived mainly from wood and cloth.

Paper has the unfortunate distinction of comprising the largest component of municipal solid waste in the United States. For instance, in 1993, 77.84 million tons of municipal solid waste paper and paperboard were generated in the U.S.—representing 37.6% of all U.S. solid waste. Only 26.46 million tons (34%) were recycled into other paper products; the remaining 51.38 million tons (66%) were discarded (EPA, Characterization of Municipal Solid Waste in U.S., 1994 Update).

The volume of waste paper continues to increase. In 1995, the EPA estimated that 81.5 million tons of municipal solid waste paper and paperboard were generated in the U.S.—comprising 39.2% of total municipal solid waste (EPA, Characterization of Municipal Solid Waste in U.S., 1996 Update).

In regard to the water component of the new material, virtually any type of water is suitable including distilled, filtered, non-filtered, chlorinated, non-chlorinated, and ordinary “tap” water. Even water that may not be suitable for human or animal consumption (because of particulates, pollutants, pH extremes, or other non-animal-tolerated properties) may be considered.

### OBJECTS AND ADVANTAGES

The present invention offers a number of objects and advantages. For example, the present invention:

a) is lighter in weight than comparable volumes of traditional cement derivatives,

b) offers greater thermal insulation “R-value” than traditional cement derivatives,

c) displays exceptional chip resistance,

d) exhibits a very smooth finish when casted, and

e) is an ecologically and environmentally conscious new structural and decorative material.

It is particularly important to emphasize the role that the new material can play in the reduction of waste paper in municipal solid waste. Use of the present invention can, in essence, be considered a major new process for “recycling” waste paper.

Additionally, since such a wide range of water types and quality can be used in the fabrication of this new material, the present invention may offer a way to use and/or recycle marginal quality or “polluted” water that would otherwise be too costly to purify for human or animal consumption.

Readers will find further objects and advantages of the present invention from a consideration of the ensuing description.

### DETAILED DESCRIPTION

The present invention was first reduced to practice on Feb. 11, 1995. Investigations of the new material have been ongoing, and a variety of exciting applications have been discovered.

The present invention is comprised of a mixture of three primary components: pulped paper, cement, and water.

A wide variety of paper sources will suffice for the pulped paper component, including paper from:

newspapers,

books,

magazines,

office papers (such as those used for photocopying),

telephone books,

envelopes and other post office mailing materials,

tissue papers,

paper towels,

paper plates,

corrugated boxes,

paper bags, and

wrapping papers.

In fact, no paper type tested was found to be incompatible as the pulped paper component of the new material.

It should be noted that virgin paper or paper pulp of virtually any type could be used as the source of the pulped paper component. However, one of the significant benefits of the present invention is its use for “recycling” waste papers.

Virtually any method of pulping paper (from manual pulping to industrial high-volume pulping) is suitable for preparing the pulped paper component of the new material. For the initial investigation of the properties of the new material, the preparation of the pulped paper component was generally as follows:

1) The paper component was manually-shredded into thin strips via a traditional paper cutter. (As noted previously, virtually any paper type can suffice as the source for the pulped paper component. For most of the experimentation, however, newspaper was selected since it is one of the largest contributors to waste paper.)

2) Approximately 16 ounces (volume) of the shredded paper was then added to the mixing unit of an ordinary tabletop blender (“Counter Craft” model produced by Sears).

3) Two cups (16 ounces) of distilled water was then added to the mixing unit. (It should be noted that distilled water was used simply to minimize research variables. Through additional testing, it has been found that ordinary water, as commonly used in the preparation of traditional cement derivatives, is perfectly adequate. In fact, a wide range of water types and quality are suitable for creating the new material.)

4) The blender was then set on its fastest blending speed (Speed 14, Liquefy) and run for approximately two minutes to assure thorough pulping.

5) Any non-absorbed water was then drained off.

6) The resulting water-saturated pulped paper was then used in the research of the new material.

For convenient storage and transport, the prepared pulped paper component may also be dried (using any of a number of common drying or dehydration procedures) to remove the water content.

Experimentation has shown that both the dried and the water-saturated pulped paper work equally well. If dry pulped paper is used in the preparation of the new material, it is important to compensate for the dryness by increasing the water that is added to the mixture. As long as the total water content of the mixture is correct, either pulped paper type may be used.

The present invention can be made using a wide variety of proportions of the three primary components. The properties of the resulting solidified mixture will vary depending upon the chosen ratios of the components.

For instance, a 2:4:3 ratio by volume of pulped paper, cement, and total water will result in a cured material that is heavier and exhibits greater structural strength than an equal volume of cured material created via a 3:4:3 ratio of pulped paper, cement, and total water. However, due substantially to its proportionally higher pulped paper content, the material resulting from the 3:4:3 ratio will have a greater thermal insulation “R-value” than the material created with the 2:4:3 ratio.

The aforementioned mixture ratios are just two examples of a wide spectrum of possible mixture combinations—resulting in a broad range of properties exhibited by the new material. Ongoing research includes analyzing the characteristics of the new material when the volume of each component, in relation to the other components, is varied by up to a factor of ten and greater.

There are a number of suitable methods for preparing the new material. One such method begins with selecting a container of appropriate size to hold the total volume of the three components to be mixed. The selected volume of cement is placed into the container. The selected volume of water is then added to the cement and the combination is mixed thoroughly. The selected volume of pulped paper (either water-saturated or dried) is then added, and the combination mixed thoroughly. The resulting mixture should be a uniform blend of the three components.

Aggregates, such as sand and stone, may also be included in the mixture. Standard steel reinforcing bar (re-bar) and/or metal netting may also be included. Research is underway to examine the properties of the new material when a variety of aggregates, re-bar, and/or metal netting are incorporated.

Primarily due to the water component, the ambient temperature during both the preparation and curing of the new material should be above 32 degrees Fahrenheit. Curing time generally decreases as ambient temperature increases.

The range of applications for the new material continues to be explored. Initial indications point to its suitability in a number of applications including:

1) Light-to-medium-duty structural applications, such as curbing, steps, sidewalks—possibly even highway and roadway surfaces.

2) Highway “New Jersey” barriers.

3) Roadway sound-abatement walls.

4) Decorative walls and other landscaping projects.

The new material can be easily casted, molded, shaped, machined, or cut into such items as patio bricks and decorative blocks. It can also be casted, molded, shaped, machined, or cut into rigid containers, such as flowerpots and planters.

In general, almost any light-to-medium-duty structural or decorative applications that have been typically formed of traditional concrete mixtures are viable candidates to be constructed with the new material.

As the relative volume of pulped paper to the overall mixture is decreased, the resulting strength of the new material will increase, broadening its potential to more heavy-duty applications—possibly including some areas of building construction.

The addition of aggregate materials, re-bar, and/or metal netting will modify the strength and general properties of the new material—further extending the possible applications.

The new material seems to exhibit interesting acoustical properties, such as being somewhat more sound absorbent than traditional concrete mixtures. This characteristic is likely due to the pulped paper component of the new material. Research in this particular property of the new material is ongoing.

An exciting and unexpected new application was recently discovered:

The new material exhibits characteristics (such as light in weight, mechanically strong, the ability to be casted, the ability to be machined, high temperature resistance, and high insulation “R-value”) that make it a potential candidate for the construction of nose cones on aerospace sounding rockets. Additional research is underway for this novel and valuable application.

While the invention has been described in detail with respect to the preferred embodiments thereof, it will be appreciated that upon a reading and understanding of the foregoing, certain variations will become apparent, which variations are nonetheless within the spirit and scope of the invention and the appended claims.

I claim:

1. A new structural and decorative material comprising a solidified mixture of:
a) pulped paper,
b) cement, and
c) water.

2. A method for creating a new structural and decorative material that comprises the steps of:
a) mixing together pulped paper, cement, and water, and b) allowing the mixture to cure to form a solid mass.

3. A new structural and decorative material comprising a solidified mixture of:
a) paper pulp,
b) cement, and
c) water.

4. A method for creating a new structural and decorative material that comprises the steps of:
a) mixing together paper pulp, cement, and water, and
b) allowing the mixture to cure to form a solid mass.
